(19) United States
(12) Patent Application Publication
(10) Pub. No.: US 2015/0116336 A1
(43) Pub. Date: Apr. 30, 2015

(54) DISPLAY DEVICE

(71) Applicants: Keito Yoshimura, Tokyo (JP); Mitsuo Shimotani, Tokyo (JP)

(72) Inventors: Keito Yoshimura, Tokyo (JP); Mitsuo Shimotani, Tokyo (JP)

(73) Assignee: Mitsubishi Electric Corporation, Tokyo (JP)

(21) Appl. No.: 14/398,850

(22) PCT Filed: Jun. 5, 2012
(86) PCT No.: PCT/JP2012/064413

§ 371 Date: Nov. 4, 2014

(51) Int. Cl. G06F 1/32; G09G 5/00

(52) U.S. Cl. CPC G06F 1/3265; G06F 1/3206; G09G 5/006; G09G 2380/10; G09G 2360/08; G09G 2330/023
USPC 345/520

(57) ABSTRACT

It is an object of the present invention to provide a technique capable of saving energy in a drawing process while avoiding damage on the convenience of a display device. In order to achieve this object, a display device of the present invention includes an information processing executing unit having a normal mode prepared as an operation mode for a normal drawing process and one or more energy-saving modes prepared as operation modes for drawing processes in which energy is consumed less than in the normal mode. The information processing executing unit executes information processing in the operation mode. The display device includes: an operation mode determining unit that determines an operation mode; a controller that controls the operation of the information processing executing unit; and a drawing unit that executes a drawing process.

### TECHNICAL FIELD

The present invention relates to a display technique to be applied to mobile objects such as cars, bicycles, and human beings.

### BACKGROUND ART

A navigation device has been in widespread use in recent years that searches for a route from a departure point to a destination and presents the searched route, thereby guiding a mobile object to the destination along the searched route.

As an example, according to a technique disclosed in patent literature 1, a power-saving process is executed on a unit to consume fuel such as a liquid crystal display, a video unit or a digital terrestrial broadcasting unit incorporated in a navigation system mounted on an electric car based on a route from a present location to the nearest refueling point and a remaining battery capacity. This power-saving process is to turn off the power source of the unit, lower the volume of a stereo or reduce the luminance of the display if a vehicle cannot arrive at the refueling point, thereby switching the unit to consume fuel to an energy-saving status.

### PATENT ART LITERATURES

### Patent Literature

Patent Literature 1: Japanese Patent Application Laid-Open No. 2011-075290

### SUMMARY OF INVENTION

### Problems to be Solved by Invention

Turning off the power source by the technique of patent literature 1 achieves power saving. However, this in turns hinders a function inherent to a display device. As an example, where arriving at the refueling point involves a navigation function, turning off the power source disables provision of the key navigation function. This damages the convenience of the unit. Further, while the luminance of a display may be reduced by the technique of patent literature 1, a process such as calculation of a display position to consume a great deal of energy during a drawing process still continues. This hinders effective power saving. Accordingly, the technique of patent literature 1 unfortunately makes it difficult to achieve power saving without damaging convenience inherent to a display device.

The present invention has been made to solve the aforementioned problems. It is an object of the present invention to provide a technique capable of saving energy in the drawing process to consume much energy without damaging convenience inherent to a display device.

### Means of Solving Problems

A display device of the present invention includes: an information processing executing unit having a normal mode prepared as an operation mode for a normal drawing process and one or more energy-saving modes prepared as operation modes for drawing processes in which energy is consumed less than in the normal mode, the information processing executing unit executing information processing in the operation mode; an operation mode determining unit that determines an operation mode for information processing to be executed by the information processing executing unit based on a given condition; a controller that controls the operation of the information processing executing unit based on a result of a determination made by the operation mode determining unit; and a drawing unit that executes a drawing process in response to execution of information processing by the information processing executing unit.

### Advantageous Effects of Invention

According to the present invention, information processing can be executed in each of the normal mode prepared as an operation mode for a normal drawing process and in one or more energy-saving modes prepared as operation modes for drawing processes in which energy is consumed less than in the normal mode. An operation mode for information processing to be executed is determined based on a given condition. The information processing responsive to the determined operation mode is executed and then a drawing process is executed. Accordingly, a drawing process is still executed even if the energy-saving mode is selected. This enables energy saving in the drawing process to consume much energy while avoiding damage on convenience inherent to the display device.

### BRIEF DESCRIPTION OF DRAWINGS

FIG. 1 is a block diagram showing an exemplary structure of a first embodiment.

FIG. 2 includes a table showing a relationship between drawing process and power consumption.

FIG. 3 shows an exemplary driver's-eye view.

FIG. 4 shows an exemplary bird's-eye view.

FIG. 5 shows exemplary display of a planar map.

FIG. 6 shows exemplary display of a map formed by adding a townscape to the planar map of FIG. 5

FIG. 7 shows exemplary display of a map formed by adding three-dimensional images to the planar map of FIG. 5.

FIG. 8 shows exemplary change in screen display in the absence of an animation.

FIG. 9 shows exemplary change in screen display in the presence of an animation.

FIG. 10 includes a table showing exemplary settings relating to possibility of map display responsive to an operation mode.

FIG. 11 includes a table showing exemplary settings of an operation mode responsive to a remaining battery capacity and the possibility of arrival at a destination.

FIG. 12 is a flowchart showing exemplary operation of the first embodiment.

FIG. 13 is a block diagram showing an exemplary structure of a second embodiment.

FIG. 14 includes a table schematically showing the structure of an exemplary drawing database.

FIG. 15 includes a table schematically showing the structure of an exemplary drawing database.

FIG. 16 includes a table schematically showing the structure of an exemplary drawing database.

FIG. 17 includes a table schematically showing the structure of an exemplary drawing database.

FIG. 18 is a flowchart showing exemplary operation of the second embodiment.

FIG. 19 is a block diagram showing an exemplary structure of a third embodiment.

FIG. 20 shows an exemplary display plan using an energy-saving mode.

FIG. 21 shows an exemplary display plan using the energy-saving mode.

FIG. 22 shows an exemplary screen for a normal mode.

FIG. 23 shows an exemplary screen for the energy-saving mode.

FIG. 24 shows an exemplary screen for the energy-saving mode.

FIG. 25 shows an exemplary screen for the energy-saving mode.

FIG. 26 shows switching between a screen for the normal mode and a screen for the energy-saving mode.

FIG. 27 is an exemplary route guidance screen to be displayed during route guidance.

FIG. 28 is an exemplary route guidance screen to be displayed during route guidance.

FIG. 29 is a flowchart showing exemplary operation of the third embodiment.

### DESCRIPTION OF EMBODIMENT(S)

Embodiments of the present invention will be described below based on the drawings. In the drawings, corresponding structures and parts having the same function are identified by the same signs. These structures and parts are not described repeatedly in the description given below. Each of the drawings is given as a schematic drawing. As an example, the size of a displayed object, the positions of displayed objects relative to each other and the like are not always accurately illustrated in each of the drawings.

### A. First Embodiment

### A-1. Overall Structure of Navigation Device

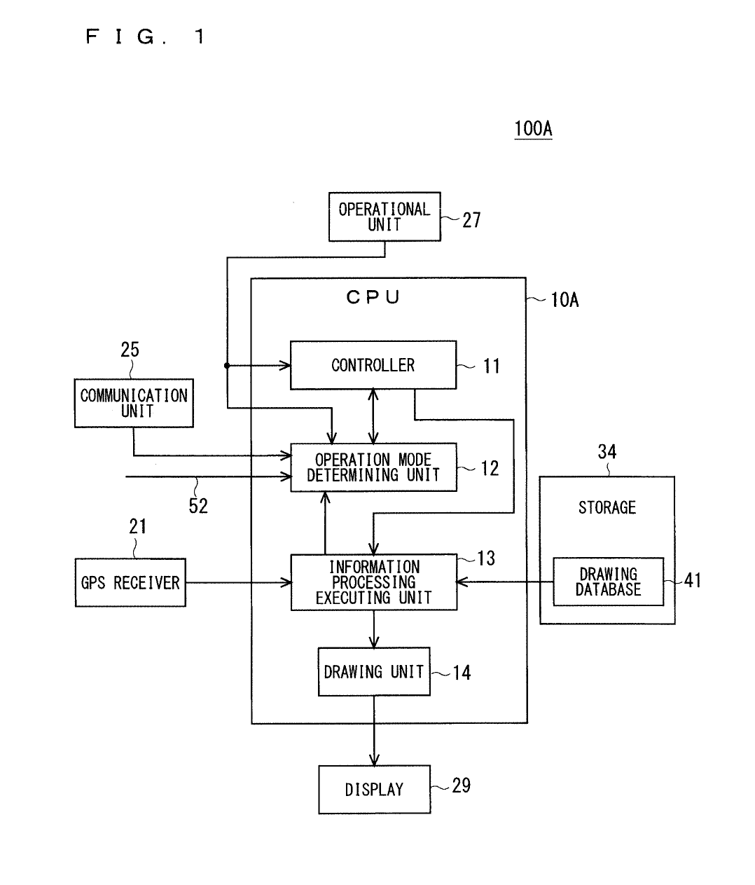

FIG. 1 is a block diagram showing an exemplary structure of a navigation device 100A for a vehicle (mobile object) described as an example of a display device for a mobile object according to a first embodiment. The navigation device 100A is a navigation device mounted on a vehicle.

The navigation device 100A is a device capable of achieving realistic and effective energy saving in a situation where energy saving is requested by reducing energy to be consumed in drawing process without hindering a function essentially required for navigation. Where multiple energy savings differing from each other in terms of a degree of energy saving are required, the navigation device 100A executes drawing process sequences differing from each other in response to respective degrees of energy saving, thereby reducing a calculation load in drawing process to reduce energy to be consumed in the drawing process without hindering an essential function.

The navigation device 100A includes a CPU 10A, a GPS receiver 21, a communication unit 25, a storage 34, and others. The CPU 10A controls each unit of the navigation device 100A to comply with given timing according to a stored program, thereby controlling the operation of the entire navigation device 100A. The GPS receiver 21 receives radio waves from a GPS satellite. The communication unit 25 receives traffic information of various types such as regulation information, disturbance information and jam information provided for example in FM multiplex broadcasting or from various beacons arranged along a road. The storage 34 stores a drawing database 41. The drawing database contains a map database and data for use in drawing an icon to be displayed on a menu screen, for example.

The navigation device 100A further includes an operational unit 27 functioning as a user interface and a display 29 for display of a map and the like. The operational unit 27 is formed for example of a touch panel and an operational button. By operating the operational unit 27, a user can set a destination, a condition for a route search and the like. This operation also enables the user to set an operation mode of the navigation device 100A.

In the navigation device 100A, display action can be done on the display 29 in response to a normal mode and an energy-saving mode in which energy is consumed less than in the normal mode. The energy-saving mode may have energy-saving modes of multiple levels responsive to degrees of energy saving. If a route is not to be guided, the navigation device 100A detects a current location of a vehicle on which the navigation device 100A is mounted and displays the present location in a superimposed manner on a map on the display 29. If a route is to be guided, the navigation device 100A searches for a route and displays the searched route and the present location of the vehicle in a superimposed manner on the map, thereby guiding the route. The navigation device 100A further makes display action for a menu screen for operation and a voice spectrum while an AV device not shown in the drawings operates, for example.

The display action (“graphics”) mentioned herein involves many calculations, leading to large energy consumption. More specifically, energy consumption becomes larger if an image to be drawn changes more drastically. Energy consumption also becomes larger if an image to be drawn has a more complicated content. Accordingly, a displaying action for navigation involving display of a map consumes a particularly large amount of energy among various displaying actions. Like in navigation, displaying the power spectrum of a voice consumes a large amount of energy while a map is not referred to in this case.

For the purpose of achieving energy saving in the display action, the navigation device 100A has multiple drawing process sequences of different degrees of energy saving responsive to the normal mode and the energy-saving mode. By executing a drawing process sequence responsive to a degree of energy saving, the navigation device 100A tries to save energy in the drawing process while minimizing hindrance to a navigation function.

The CPU 10A also functions as a controller 11, an operation mode determining unit 12, an information processing executing unit 13, a drawing unit 14, and the like.

In response to supply of operational information about a user from the operational unit 27, the controller 11 controls the operation of the entire navigation device 100A. The controller 11 controls the information processing executing unit 13 to make the information processing executing unit 13 execute information processing of various types. The information processing of various types mentioned herein may include for example a navigation process, a browsing process, AV processing, telematics, and emergency support. The controller 11 controls the operation of the information processing executing unit 13 based on a result of a determination by the operation mode determining unit 12, thereby making the information processing executing unit 13 executes certain information processing relating to drawing process.

The operation mode determining unit 12 receives operational information about a user supplied from the operational unit 27, traffic information of various types received by the communication unit 25, and vehicular information 52 indicating a remaining battery capacity or a remaining gasoline capacity of a vehicle on which the navigation device 100A is mounted. If the vehicle is a hybrid electric car to travel using both an internal combustion engine and a motor, information indicating whether the vehicle is traveling in an electric car mode is also supplied as the vehicular information 52 to the operation mode determining unit 12. Based on a given condition relating to these pieces of information, the operation mode determining unit 12 determines whether the navigation device 100A is to execute a drawing process in the normal mode or in the energy-saving mode. A result of the determination is supplied to the controller 11.

If the navigation device 100A is to operate in multiple energy-saving modes of different degrees of energy saving, while determining whether drawing process is to be executed in the normal mode or in the energy-saving mode, the operation mode determining unit 12 further determines which one of these energy-saving modes is to be employed for the drawing process and selects one operation mode to be employed.

The information processing executing unit 13 has a drawing process sequence to be executed in the normal mode and a drawing process sequence (also called “energy-saving drawing process sequence”) to be executed in the energy-saving mode to consume less energy than the former drawing process sequence. The information processing executing unit 13 has multiple energy-saving drawing process sequences responsive to corresponding ones of the multiple energy-saving modes of different degrees of energy saving. If the operation mode determining unit 12 determines that whether the normal mode or the energy-saving mode is to be employed for the drawing process, under control by the controller 11 responsive to a result of the determination, the information processing executing unit 13 executes one of the drawing process sequence for the normal mode and the energy-saving drawing process sequence responsive to the result of the determination.

If the operation mode determining unit 12 selects one from the multiple energy-saving modes, the information processing executing unit 13 executes one of the multiple energy-saving drawing process sequences under control by the controller 11. This execution realizes information processing relating to drawing processes such as image processing of various types, thereby enabling detailed energy saving responsive to a degree of necessity of the energy-saving mode.

In response to execution of information processing by the information processing executing unit 13, the drawing unit 14 executes the drawing process responsive to this information processing and displays a screen such as a guidance screen or a menu screen responsive to a target degree of target energy saving on the screen of the display 29.

### A-2. Energy to be Consumed in Various Drawing Processes

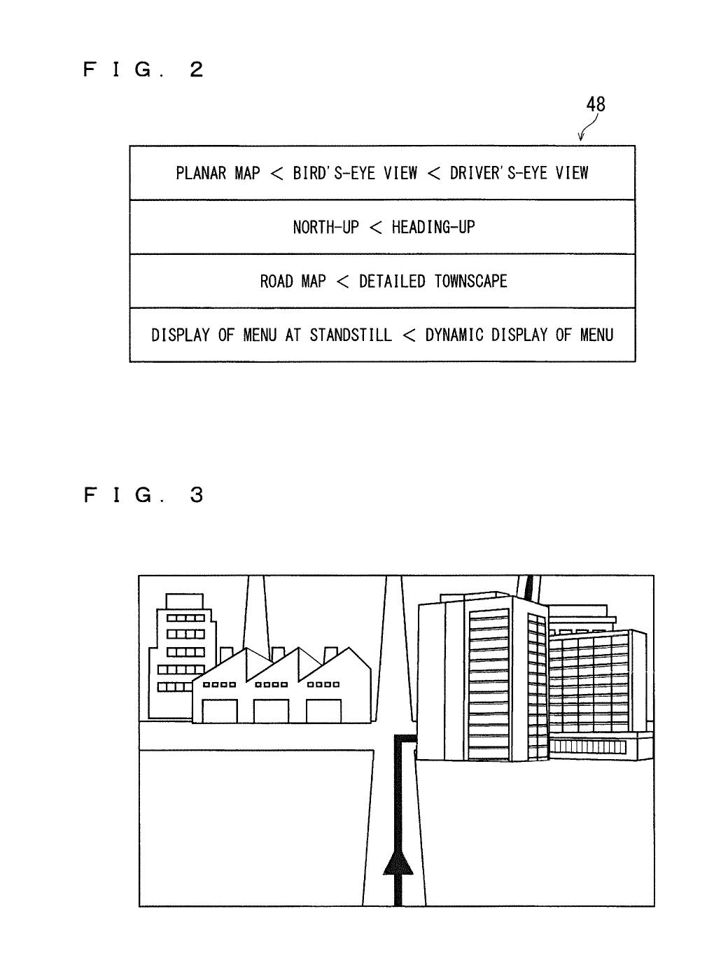

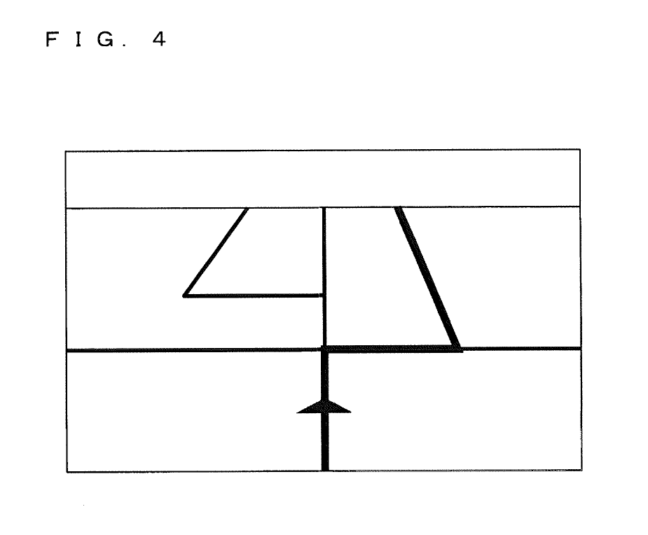

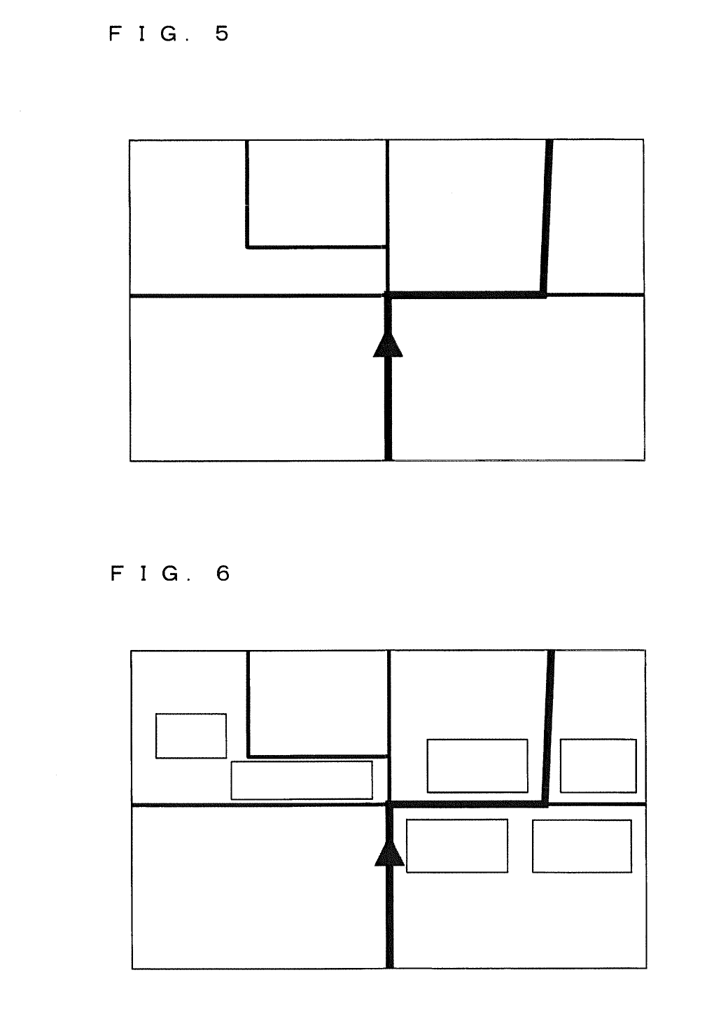

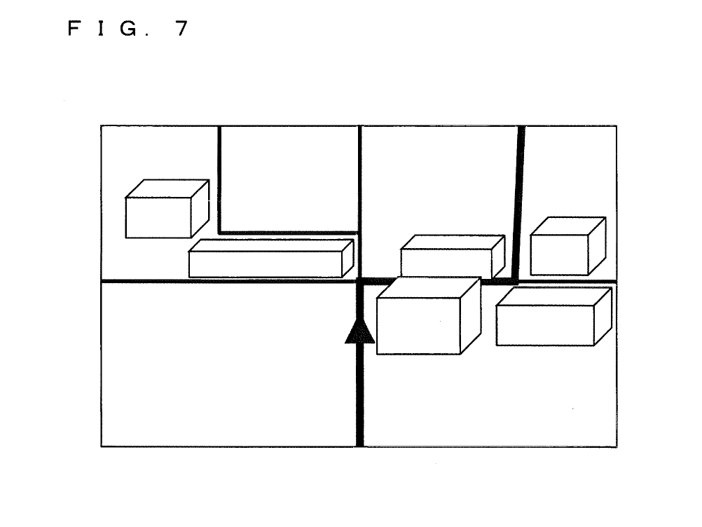

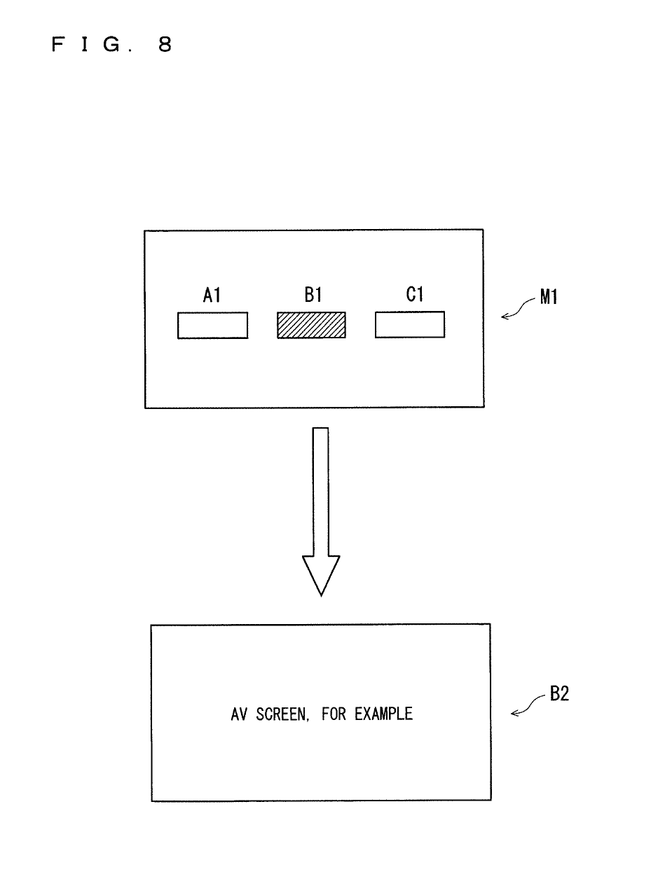

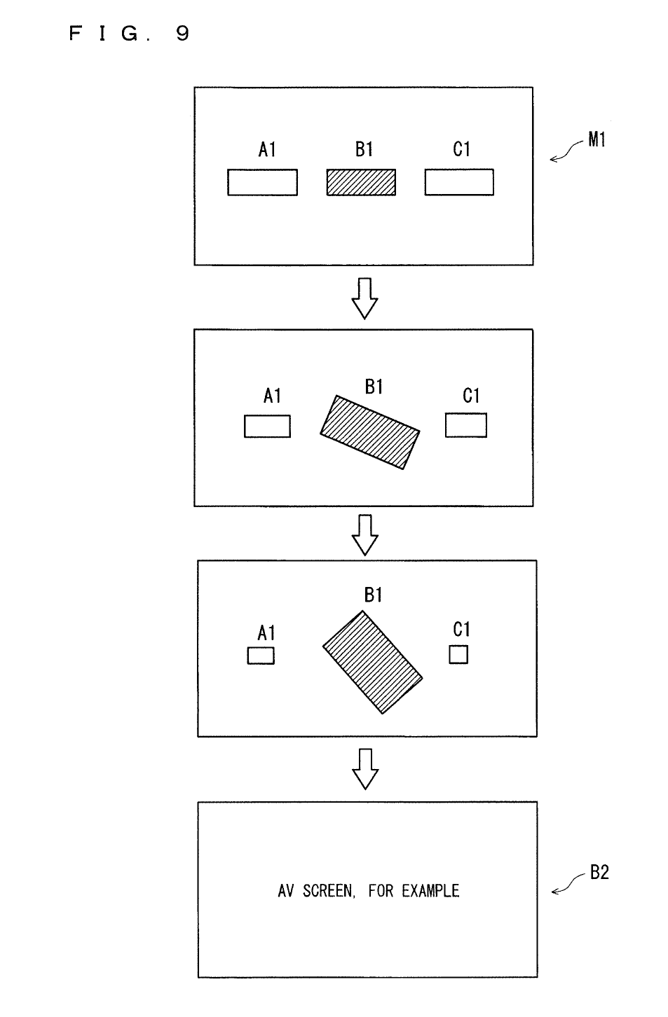

FIG. 2 includes Table 48 showing a relationship between various drawing processes and power consumption. Each row in Table 48 includes three or two drawing processes aligned from left to right while divided by inequality signs or an inequality sign in the order of increasing energy consumption. FIGS. 3 to 5 show an exemplary driver's-eye view, an exemplary bird's-eye view, and an exemplary planar map respectively displayed on a screen. A calculation load required for drawing increases in the order as shown in the top row in Table 48, so that energy consumption changes in this order. Further, heading-up involves changes of a screen in response to travel of a vehicle that are made at a higher frequency than north-up. Accordingly, as shown in the second row from the top in Table 48, heading-up consumes more energy. FIG. 6 shows exemplary screen display of a map formed by adding a townscape such as a residential map to the planar map of FIG. 5. The presence of the townscape complicates a display content, thereby increasing energy consumption. FIG. 7 shows exemplary screen display of a map formed by adding three-dimensional images to the planar map of FIG. 5. Adding the three-dimensional images also increases energy consumption. FIG. 8 shows exemplary switching between screen displays in the absence of an animation. FIG. 9 shows exemplary switching between screen displays in the presence of an animation. FIGS. 8 and 9 show a menu screen M1 on which three operational icons A1 to C1 are displayed and illustrate how the menu screen M1 is switched to a screen B2 such as an AV screen relating to the icon B1 in response to selection of the icon B1. As shown in FIGS. 8 and 9, the presence of an animation facilitates understanding of association between the screens before and after the switching, compared to the absence of an animation. However, the animation consumes a great deal of energy. Accordingly, as shown in the fourth row from the top in Table 48, displaying a menu screen dynamically using animation consumes more energy than displaying the menu screen at standstill.

### A-3. Energy-Saving Process by Navigation Device 100A

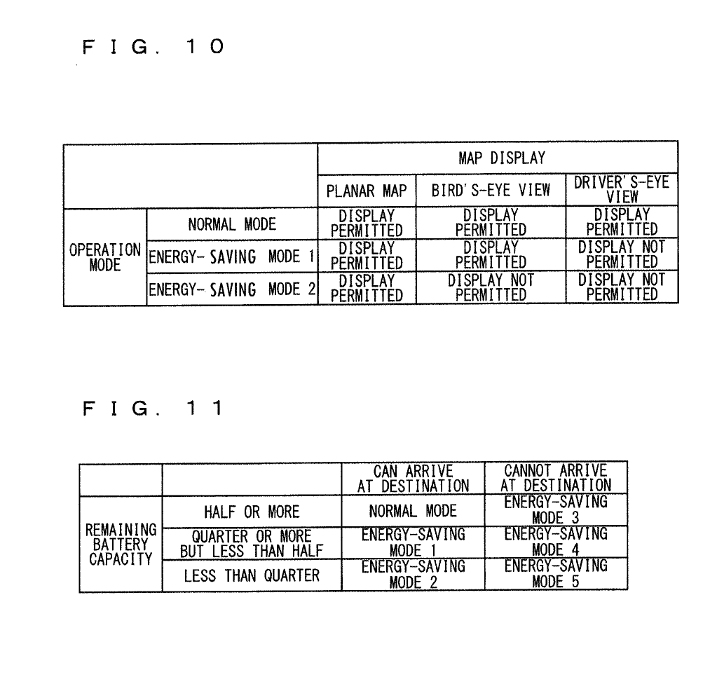

The navigation device 100A executes a drawing process sequence as the energy-saving drawing process sequence that is subjected to more strict constraint on display action than a drawing process sequence to be executed in the normal mode, thereby achieving energy saving in the drawing process. The constraint on display action may be constraint relating to at least one of a frequency of change of drawing and a content of drawing. The constraint on display action may also be restriction of a frequency of heading-up display update or prohibition of heading-up display, prohibition of 3D display of a building, prohibition of display of a townscape such as a residential map, prohibition of display of a narrow street, or prohibition of display of dynamic action such as an animation, for example. FIG. 10 includes a table showing exemplary settings relating to possibility of map display responsive to an operation mode. As an example, if there are two types of modes including the normal mode and the energy-saving mode, at least one of bird's-eye view display and driver's-eye view display is prohibited in an energy-saving drawing sequence. Action of displaying a planar map, a bird's-eye view, a driver's-eye view and the like is subjected to constraint in response to the energy-saving mode.

Such constraint on display action contributes to reduction in a frequency of display update or simplification of a display content, thereby achieving energy saving during the drawing process. In such an energy-saving process, a map itself is displayed while the map is displayed in a changed style, thereby allowing the navigation device 100A to fulfill a navigation function. The aforementioned energy-saving processes may be executed in combination, if appropriate. Combining these energy-saving processes can set a degree of energy saving finely in a large number of levels, thereby facilitating achievement of both a navigation function and energy saving.

### A-4. Condition for Energy-Saving Mode

The operation mode determining unit 12 determines an operation mode based on a given condition.

If a vehicle on which the navigation device 100A is mounted is a hybrid electric car or an electric car, the operation mode determining unit 12 may determine an operation mode based on a remaining battery capacity. If the vehicle on which the navigation device 100A is mounted is a gasoline car, the operation mode determining unit 12 may determine an operation mode based on a remaining gasoline capacity. As an example, if the remaining battery capacity is half or more, the operation mode determining unit 12 determines that the normal mode is to be employed. If the remaining battery capacity is quarter or more but less than half, the operation mode determining unit 12 determines that an energy-saving mode 1 is to be employed. If the remaining battery capacity is less than quarter, the operation mode determining unit 12 determines that an energy-saving mode 2 is to be employed. The energy-saving mode 1 mentioned herein is an operation mode in which energy is consumed less than in the normal mode. The energy-saving mode 2 mentioned herein is an operation mode in which energy is consumed less than in the energy-saving mode 1. The operation mode determining unit 12 determines that an operation mode in which less energy is consumed (operation mode of a higher degree of energy saving) is to be employed in response to reduction of the remaining battery capacity.

If the navigation device 100A makes display action in the normal mode, the operation mode determining unit 12 may determine based on an energy condition (remaining battery capacity or remaining gasoline capacity) of a vehicle (mobile object) on which the navigation device 100A is mounted whether the vehicle can arrive at the nearest energy replenishing facility or a destination and determine an operation mode based on a result of the determination. If a result of the determination shows that the vehicle cannot arrive at the nearest energy replenishing facility, the operation mode determining unit 12 determines that drawing process is to be executed in the energy-saving mode, for example. Such process enables the navigation device 100A to execute a drawing process in the energy-saving mode where energy saving is required and execute a drawing process in the normal mode where energy saving is not required.

FIG. 11 includes a table showing exemplary settings of an operation mode responsive to a remaining battery capacity and the possibility of arrival at a destination. As shown in FIG. 11, the operation mode determining unit 12 may determine an operation mode based on a combination of a result of a determination as to the possibility of arrival at the destination and the remaining battery capacity (or remaining gasoline capacity). Energy consumption becomes lower in an energy-saving mode 1, an energy-saving saving mode 2, and an energy-saving mode 3 in the order named. The operation mode determining unit 12 selects an operation mode of lower energy consumption with reduction in the remaining battery capacity. The operation mode determining unit 12 selects an operation mode of lower energy consumption for the case where arrival at the destination is not feasible than energy consumption for the case where arrival at the destination is feasible.

The operation mode determining unit 12 can also determine whether the vehicle can arrive at the destination and the like based on road traffic information received by the communication unit 25. In this case, the possibility for the vehicle to arrive at the destination and the like can be determined more accurately, so that the drawing process can be executed in the energy-saving mode to comply with more appropriate timing.

If the aforementioned vehicle is a hybrid electric car, the operation mode determining unit 12 may determine whether the vehicle is traveling in an electric car mode. As an example, if a result of the determination shows that the vehicle is traveling in the electric car mode, the operation mode determining unit 12 determines that the drawing process is to be executed in the energy-saving mode. This enables navigation while ensuring supply of power from a battery to a motor more reliably.

The operation mode determining unit 12 may also determine an operation mode based on user's operation performed through the operational unit 27. Accordingly, if a user hopes to execute the drawing process in the normal mode while the energy-saving mode is employed, a route guidance in the normal mode can still be offered to the user. This enhances convenience of the user.

If detecting the occurrence of an unexpected issue such as accident information, disaster information or jam information through the communication unit 25, the operation mode determining unit 12 determines that the drawing process is to executed in the normal mode. The occurrence of the unexpected issue requires more information for the purpose of avoidance, for example. Making this determination in the case actually in need of information gives higher priority to provision of necessary information than energy saving, thereby allowing a user to take appropriate action. The operation mode determining unit 12 may release this control after elapse of a given period of time or if the operation mode determining unit 12 determines that a given condition is satisfied, for example.

### A-5. Operation of Navigation Device 100A

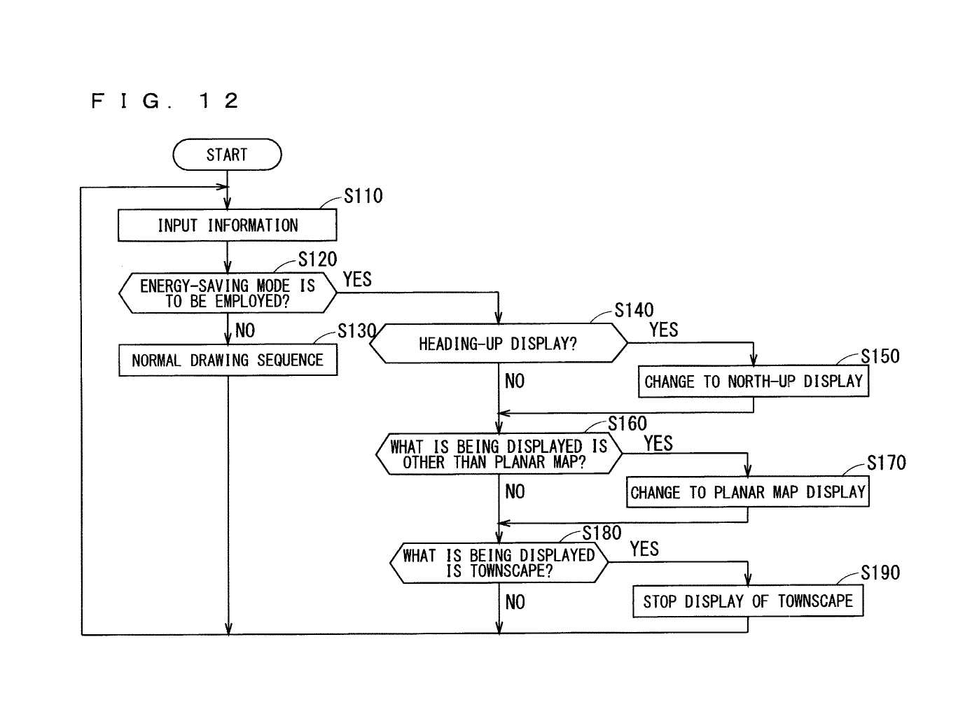

FIG. 12 is a flowchart showing exemplary operation of the navigation device 100A for a vehicle having two operation modes including the normal mode and the energy-saving mode described as an example of the display device for a mobile object according to the first embodiment.

When a vehicle on which the navigation device 100A is mounted starts to travel, certain information such as operational information about a user or the vehicular information 52 required for determining an operation mode of the navigation device 100A is input to the operation mode determining unit 12 (step S110). The operation mode determining unit 12 determines based on a given condition whether the energy-saving mode is to be employed (step S120). If a result of the determination shows that the energy-saving mode is not to be employed, the information processing executing unit 13 executes a drawing process sequence in the normal mode under control by the controller 11 (step S130). If a result of the determination in step S120 shows that the energy-saving mode is to be employed for the drawing process, it is determined whether heading-up display is being made (step S140). If a result of the determination shows that heading-up display is being made, the information processing executing unit 13 changes heading-up display to north-up display (step S150). Then, the processing shifts to step S160. If a result of the determination in step S140 shows that heading-up display is not being made, it is determined whether what is being displayed is other than a planar map (step S160). If a result of this determination shows that what is being displayed is other than a planar map, the information processing executing unit 13 executes a drawing process sequence responsive to display of a planar map (step S170). Then, the processing shifts to step S180. If a result of the determination in step S160 shows that a planar map is being displayed, it is determined whether what is being displayed is a townscape (step S180). Then, the processing returns to step S110. If a result of this determination shows that a townscape is being displayed, the information processing executing unit 13 stops display of the townscape (step S190). Then, the processing returns to step S110.

The display device of the aforementioned structure according to the first embodiment is capable of executing information processing in each of the normal mode prepared as an operation mode for a normal drawing process and in one or more energy-saving modes prepared as operation modes for drawing processes in which energy is consumed less than in the normal mode. An operation mode for information processing to be executed is determined based on a given condition. The information processing responsive to the determined operation mode is executed and then a drawing process is executed. Accordingly, a drawing process is still executed even if the energy-saving mode is selected. This enables energy saving in the drawing process to consume much energy while avoiding damage on convenience inherent to the display device.

In this embodiment, the respective functions of the units 11, 12, 13 and 14 are fulfilled by the CPU 10A. These functions may be fulfilled by an SOC (system on chip) intended to fulfill the function of a GPU (graphics processing unit) or a CPU or other functions in one chip or by a different hardware structure.

Even if the display device of the first embodiment is not the navigation device 100A but it may be a smartphone, a mobile phone, a PND (portable navigation device), a PDA (personal digital assistance) or a tablet PC, for example, the usefulness of the present invention is still maintained.

### B. Second Embodiment

### B-1. Overall Structure of Navigation Device

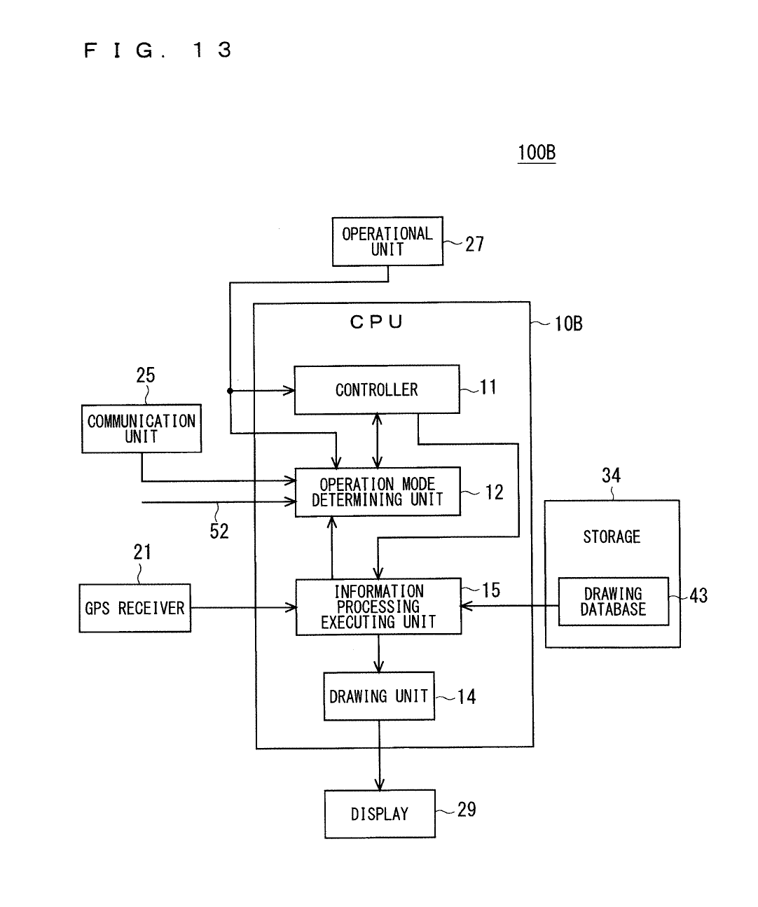

FIG. 13 is a block diagram showing an exemplary structure of a navigation device 100B for a vehicle described as an example of a display device for a mobile object according to a second embodiment. The navigation device 100B is a navigation device mounted on a vehicle.

Like the navigation device 100A of the first embodiment, the navigation device 100B is a device capable of achieving realistic and effective energy saving in a situation where energy saving is requested by reducing energy to be consumed in a drawing process without hindering a function essentially required for navigation. The navigation device 100B executes a drawing process using a drawing object classified in advance according to a calculation load required for the drawing process, thereby reducing the calculation load in the drawing process to reduce energy to be consumed in the drawing process without hindering an essential function. A drawing object is classified for example in a way of associating a parameter for classification with each drawing object or in a way of preparing multiple drawing databases to store drawing objects and classifying the drawing objects in units of drawing databases.

The navigation device 100B includes a CPU 10B, a GPS receiver 21, a communication unit 25, a storage 34, and others. The navigation device 100B further includes an operational unit 27 functioning as a user interface and a display 29 for display of a map and the like. The CPU 10B controls each unit of the navigation device 100B to comply with given timing according to a stored program, thereby controlling the operation of the entire navigation device 100B. The CPU 10B also functions as a controller 11, an operation mode determining unit 12, an information processing executing unit 15, a drawing unit 14, and the like. The storage 34 stores a drawing database 43.

In the navigation device 100B of the second embodiment, the information processing executing unit 15 (and the CPU 10B including the information processing executing unit 15) and the drawing database 43 are constituent elements different from those of the navigation device 100A of the first embodiment. The information processing executing unit 15 and the drawing database 43 are described below. Like in the navigation device 100A of the first embodiment, the operation mode determining unit 12 determines based on a given condition which one of two or more operation modes associated with energy to be consumed in drawing processes is to be employed for the drawing process.

The drawing database 43 has a binary or multivalued mode parameter (also called “energy-saving parameter”) value associated with energy to be consumed in a drawing process for each drawing object or for each attribute of a drawing object. This mode parameter value indicates the possibility of display of a drawing object responsive to an operation mode. The storage 34 (“drawing database storage”) stores the drawing database 43 input from an external server center and the like where necessary. Alternatively, the drawing database 43 may be stored in advance inside the navigation device 100B.

The information processing executing unit 15 executes information processing using the drawing database 43 in response to both an operation mode determined by the operation mode determining unit 12 and a mode parameter shown in the drawing database 43. The drawing unit 14 executes the drawing process in response to execution of this information processing.

### B-2. Drawing Database for Navigation Device 100B

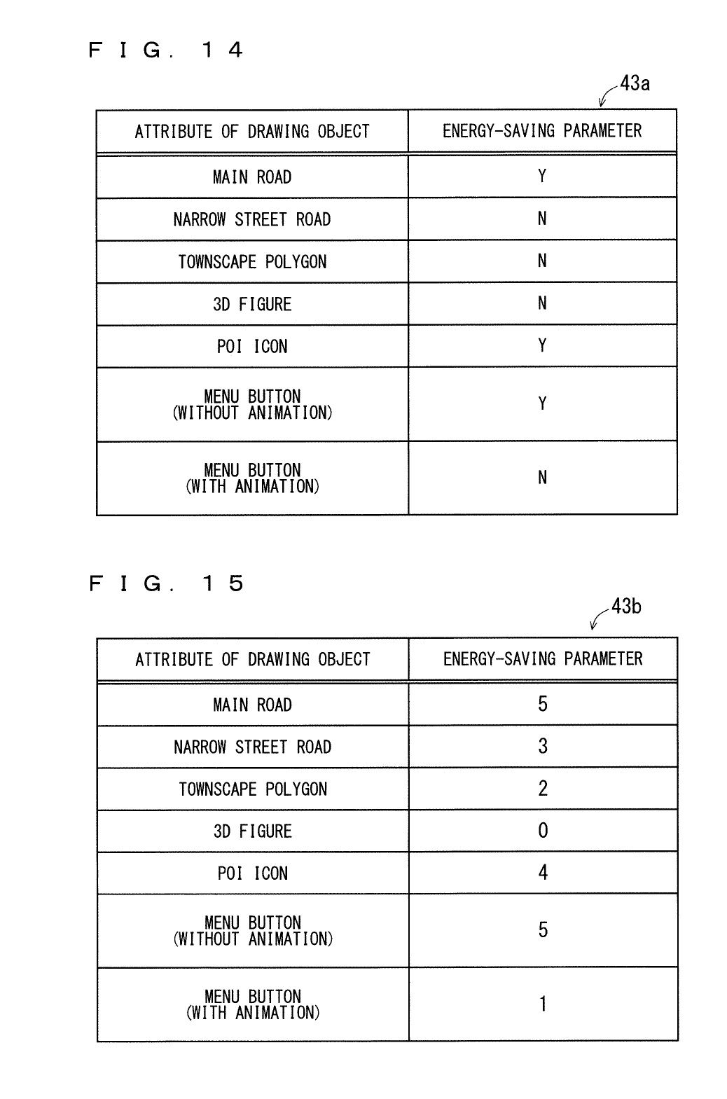

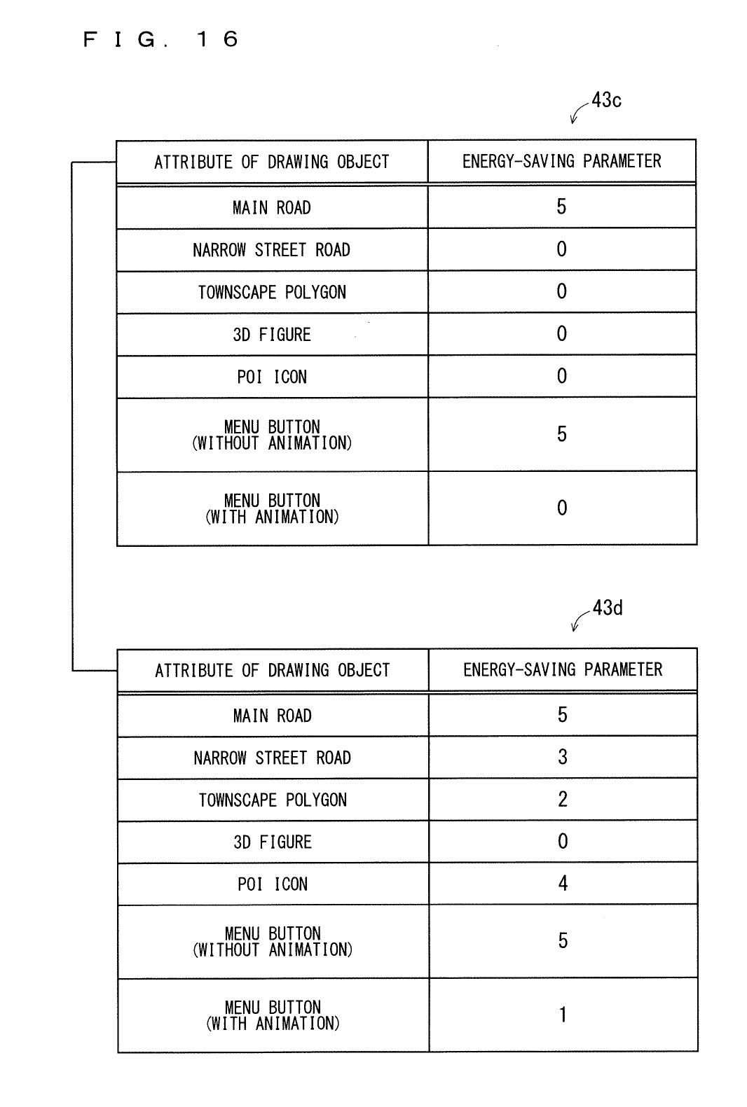

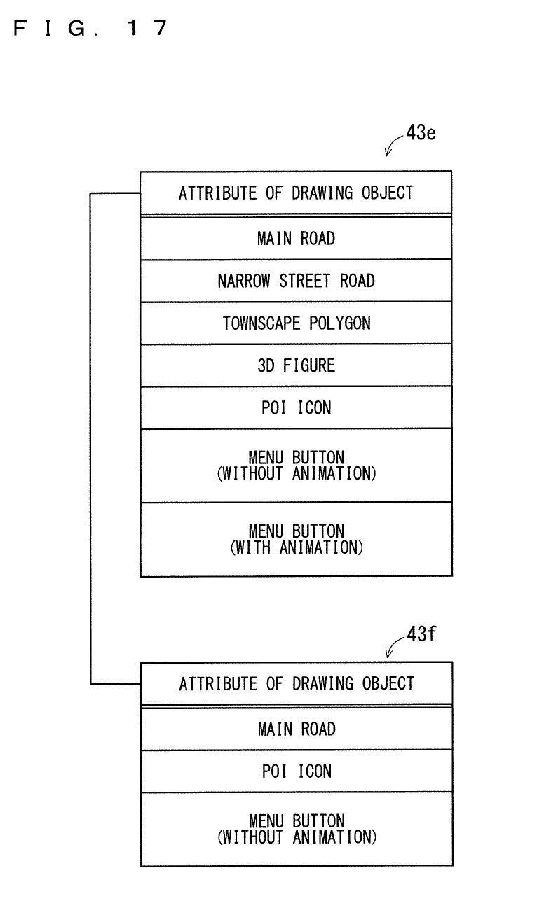

FIGS. 14 and 15 include tables schematically showing the structure of a drawing database 43a and that of a drawing database 43b respectively described as examples of the drawing database 43. FIG. 16 includes a table schematically showing the structure of a drawing database 43c and that of a drawing database 43d described as examples of the drawing database 43. In each of FIGS. 14 to 16, an energy-saving parameter is set for each attribute of a drawing object. FIG. 17 includes a table schematically showing the structure of a drawing database 43e and that of a drawing database 43f described as examples of the drawing database 43.

The drawing database 43a (FIG. 14) is an example of the drawing database 43 (FIG. 13) employed if the navigation device 100B is to operate in two operation modes including a normal mode and an energy-saving mode. The drawing database 43a includes drawing objects of seven types of attributes. An energy-saving parameter of a value “Y” or “N” is associated with each attribute of a drawing object. A drawing object of an attribute associated with an energy-saving parameter of the value “N” is to be drawn in the normal mode and is not to be drawn in the energy-saving mode. A drawing object of an attribute associated with an energy-saving parameter of the value “Y” is to be drawn both in the normal mode and in the energy-saving mode.

According to the examples in the drawing database 43a, “3D figure” corresponding to an attribute of a drawing object used for drawing of a building to be displayed in three dimensions has an energy-saving parameter of the value “N” indicating that this object is not to be drawn in the energy-saving mode. Further, “narrow street road” corresponding to an attribute of a drawing object used for drawing of a narrow street, “townscape polygon” corresponding to an attribute of a drawing object used for drawing of a townscape, and “menu button (with an animation)” corresponding to an attribute of a drawing object used for dynamic display such as an animation, have respective energy-saving parameters of the value “N.”

In the drawing database 43b shown in FIG. 15, an energy-saving parameter of a six-level value is assigned to each attribute of a drawing object. As an example, if an operation mode is an energy-saving mode n, a drawing object of an attribute having an energy-saving parameter of n or more is drawn. If an operation mode is the normal mode, a drawing object of an attribute having an energy-saving parameter of 0 or more, specifically drawing objects of all attributes are drawn. If an operation mode is an energy-saving mode 3, a drawing object of an attribute having an energy-saving parameter of 3 or more is drawn. Specifically, in this case, drawing objects of attributes having energy-saving parameters of 3, 4 and 5 are drawn.

The drawing databases 43c and 43d (FIG. 16) are examples of databases formed by dividing the drawing database 43 into two. Drawing objects in the first drawing database 43c have energy-saving parameters of two types of values 0 and 5 assigned to corresponding attributes of drawing objects. Drawing objects in the second drawing database 43d have multilevel energy-saving parameters of values from 0 to 5. Accordingly, where the navigation device 100B has multiple drawing databases including the drawing databases 43c and 43d and these databases have respective energy-saving parameters different from each other, drawing objects of the same attribute can have different energy-saving parameters as a result of division of the drawing database. This enables the navigation device 100B to draw a target drawing object appropriately in the energy-saving mode of two or more levels.

The drawing databases 43e and 43f shown in FIG. 17 are examples of multiple drawing databases for corresponding ones of two or more operation modes associated with energy to be consumed in drawing processes. Each of these drawing databases is associated with a certain operation mode in units of drawing databases. As an example, the drawing database 43e includes only a drawing object that can be drawn in the normal mode, whereas the drawing database 43f includes only a drawing object that can be drawn in the energy-saving mode.

In this case, in response to a result of a determination about an operation mode made by the operation mode determining unit 12, the information processing executing unit 15 executes information processing using one of the drawing databases 43e and 43f responsive to a result the determination. In this case, an operation mode is associated with the drawing database 43 itself, so that the navigation device 100B is only required to execute a simple process to draw only a drawing object responsive to the operation mode.

If there is one drawing database, this drawing database may be stored inside or outside the navigation device 100B. If there are two drawing databases, one of the drawing databases may be stored inside the navigation device 100B whereas the other drawing database may be stored outside the navigation device 100B. The outside drawing database may be used for energy saving whereas the inside drawing database may be used for the normal mode. These drawing databases may be used in a reverse way. Alternatively, both of these drawing databases may be stored outside the navigation device 100B or inside the navigation device 100B.

As an example, the following methods can be used in combination: a method of executing drawing process responsive to an operation mode while making a database hold association information about an operation mode like in the navigation device 100B of the second embodiment; and a method of executing drawing process responsive to an operation mode according to a program like in the navigation device 100A of the first embodiment. Alternatively, a drawing object itself may be selected according to a program and some drawing object may be given a flag indicating the possibility of drawing responsive to an operation mode. As an example, in the energy-saving mode, a 3D figure is basically determined not to be displayed according to the program. Meanwhile, some 3D figures given a flag indicating that drawing of this 3D figure is “possible” in the energy-saving mode may be drawn in the energy-saving mode.

### B-3. Operation of Navigation Device 100B

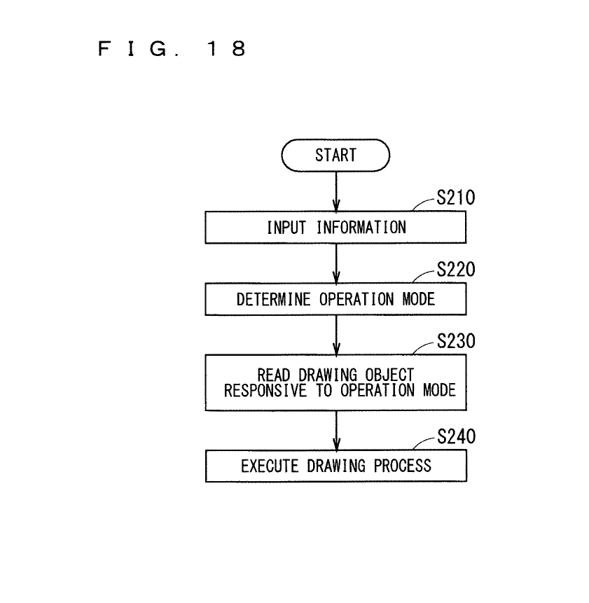

FIG. 18 is a flowchart showing exemplary operation of the navigation device 100B for a vehicle described as an example of the display device for a mobile object according to the second embodiment.

When a vehicle on which the navigation device 100B is mounted starts to travel, certain information such as operational information about a user or vehicular information 52 required for determining an operation mode of the navigation device 100B is input to the operation mode determining unit 12 (step S210). The operation mode determining unit 12 determines the operation mode based on a given condition (step S220). Under control by the controller 11, the information processing executing unit 15 reads a drawing object given an energy-saving parameter or a drawing object in a database responsive to the determined operation mode from the drawing database 43 (step S230). After the process in step S230, the drawing unit 14 executes the drawing process on the drawing object read by the information processing executing unit 15 (step S240). Then, processes in step S210 and its subsequent steps are executed repeatedly.

In the display device of the aforementioned structure according to the second embodiment, a drawing database has a binary or multivalued mode parameter value associated with energy to be consumed in a drawing process for each drawing object or for each attribute of a drawing object. This mode parameter value indicates the possibility of display of a drawing object responsive to an operation mode. Then, information processing using a drawing database is executed in response to a result of a determination made to determine which one of two or more operation modes associated with energy to be consumed in drawing processes is to be employed for the drawing process and in response to mode parameters shown in the drawing database. Next, the drawing process is executed. This enables execution of the drawing process using only a drawing object associated with energy to be consumed in the determined operation mode. This enables energy saving in the drawing process to consume much energy while avoiding damage on convenience inherent to the display device.

In the display device of the aforementioned structure according to the second embodiment, each drawing database is prepared for corresponding one of two or more operation modes associated with energy to be consumed in drawing processes. It is determined which one of the operation modes is to be employed for a drawing process. Information processing is executed using a drawing database associated with the determined operation mode. Then, the drawing process is executed. This enables execution of the drawing process using only a drawing object associated with energy to be consumed in the determined operation mode. This enables energy saving in the drawing process to consume much energy while avoiding damage on convenience inherent to the display device.

Even if the display device of the second embodiment is not the navigation device 100B but it may be a smartphone, a mobile phone, a PND (portable navigation device), a PDA (personal digital assistance) or a tablet PC, for example, the usefulness of the present invention is still maintained.

### C. Third Embodiment

### C-1. Overall Structure of Navigation Device

FIG. 19 is a block diagram showing an exemplary structure of a navigation device 100C for a vehicle described as an example of a display device for a mobile object according to a third embodiment. The navigation device 100C is a navigation device mounted on a vehicle.

Like the navigation device 100A of the first embodiment, the navigation device 100C is a device capable of achieving realistic and effective energy saving in a situation where energy saving is requested by reducing energy to be consumed in a drawing process without hindering a function essentially required for navigation. The navigation device 100C executes a drawing process using a drawing object classified in advance according to a calculation load required for the drawing process, thereby reducing the calculation load in the drawing process to reduce energy to be consumed in the drawing process without hindering an essential function. In a way to achieve such reduction, the navigation device 100C determines whether a mobile object can arrive at a destination in a normal mode. If it is determined that the mobile object cannot arrive at the destination in the normal mode, a display plan using an energy-saving mode is made according to which the energy-saving mode is employed for at least part of a route. Display is made based on this plan. This process enables the navigation device 100C to minimize a display section using the energy-saving mode.

The navigation device 100C includes a CPU 10C, a GPS receiver 21, a communication unit 25, a storage 34, and others. The navigation device 100C further includes an operational unit 27 functioning as a user interface and a display 29 for display of a map and the like. The CPU 10C controls each unit of the navigation device 100C to comply with given timing according to a stored program, thereby controlling the operation of the entire navigation device 100C. The CPU 10C also functions as a controller 11, an operation mode planning unit 16, an information processing executing unit 13, a drawing unit 14, and the like. The storage 34 stores a drawing database 41.

In the navigation device 100C of the third embodiment, the operation mode planning unit 16 is a constituent element different from those of the navigation device 100A of the first embodiment. The operation mode planning unit 16 is described below.

The operation mode planning unit 16 makes a display plan using the energy-saving mode in addition to fulfilling the function of the operation mode determining unit 12 of the navigation device 100A. The information processing executing unit 13 has a drawing process sequence to be executed in the normal mode and an energy-saving drawing process sequence.

Based on an energy condition (remaining battery capacity or remaining gasoline capacity) of a vehicle, the operation mode planning unit 16 determines whether the vehicle can arrive at a destination along a given route while the navigation device 100C makes display action in the normal mode. The operation mode planning unit 16 may make this determination in consideration of road traffic information. This enables a more accurate determination. The operation mode planning unit 16 makes this determination sequentially at a certain frequency, for example.

Regarding a destination and a route, the destination may be set and the route may be searched for in response to certain operation. Alternatively, the destination and the route may be estimated during traveling through learning based on a traveling history in the past.

If a result of this determination shows that the vehicle cannot arrive at the destination, the operation mode planning unit 16 sets at least part of the route to an energy-saving section to which the energy-saving mode is applied. The operation mode planning unit 16 sets the remaining part of the route to a normal section to which the normal mode is applied. As a result of these settings, the operation mode planning unit 16 makes a display plan using the energy-saving mode.

The controller 11 controls the operation of the information processing executing unit 13 based on this display plan to make the information processing executing unit 13 execute information processing in the form of selective execution of a drawing process sequence in the normal mode and an energy-saving drawing process sequence. In response to execution of this information processing, the drawing unit 14 executes a drawing process.

### C-2. Display Plan

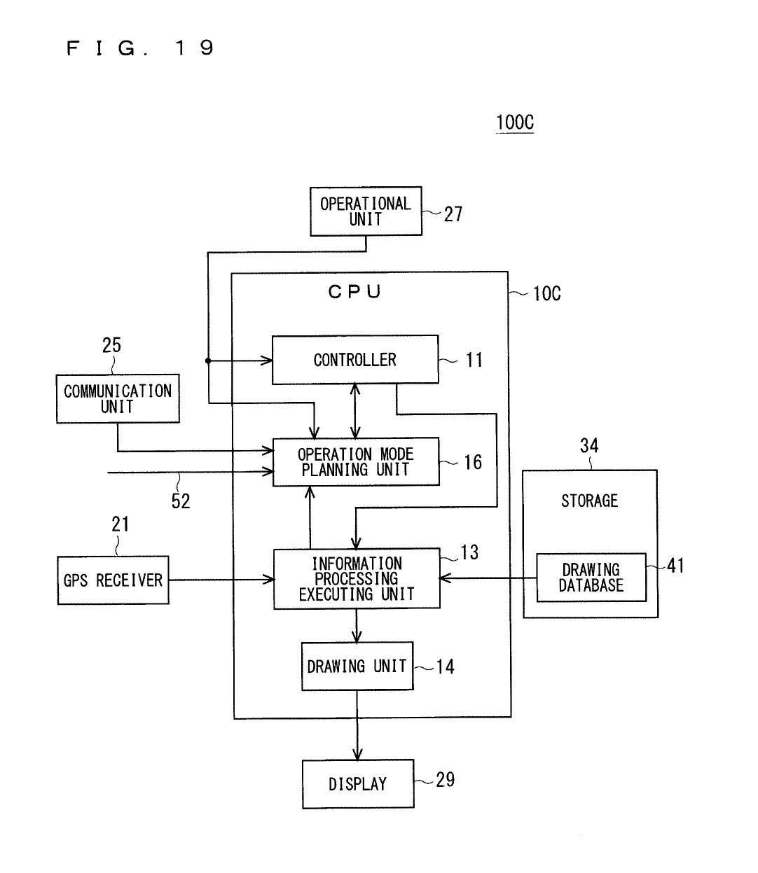

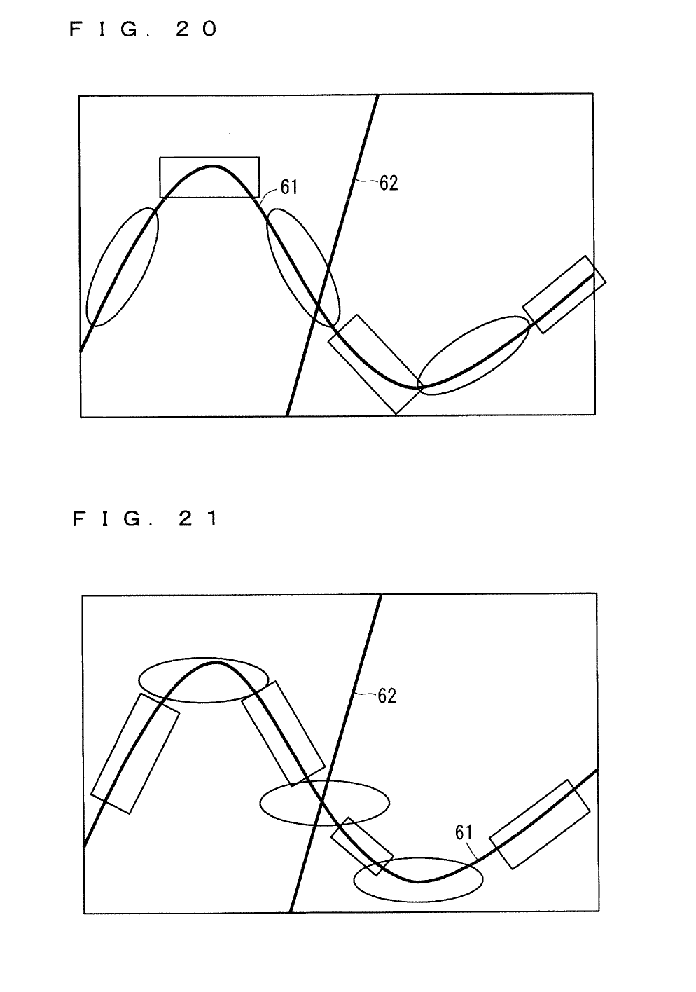

FIGS. 20 and 21 each show an exemplary display plan using the energy-saving mode. The plan shown in each of FIGS. 20 and 21 is made along a route 61 crossing a road 62. In each of FIGS. 20 and 21, oval parts show normal sections and rectangular parts show energy-saving sections.

For making the plan of FIG. 20, the operation mode planning unit 16 divides the route into a certain number of equal sections, and sets each of the equal sections to an energy-saving section or a normal section such that the energy-saving sections and the normal sections are arranged alternately along the route. As a result, a display plan can be made by simple process.

For planning sections of FIG. 21, the operation mode planning unit 16 sets a section of a certain range of the route including an intersection, a curve, an interchange, or a route guiding point to the normal section. As a result, sufficient information can be obtained at a significant point, thereby enhancing convenience.

### C-3. Screen Display in Energy-Saving Mode and Screen Display for Route Guidance

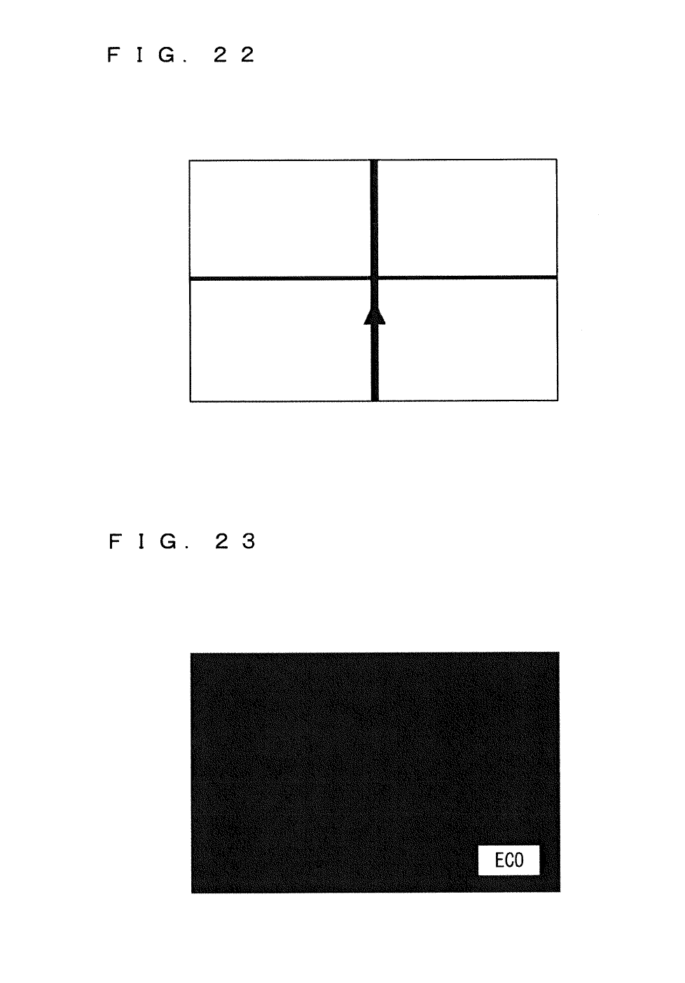

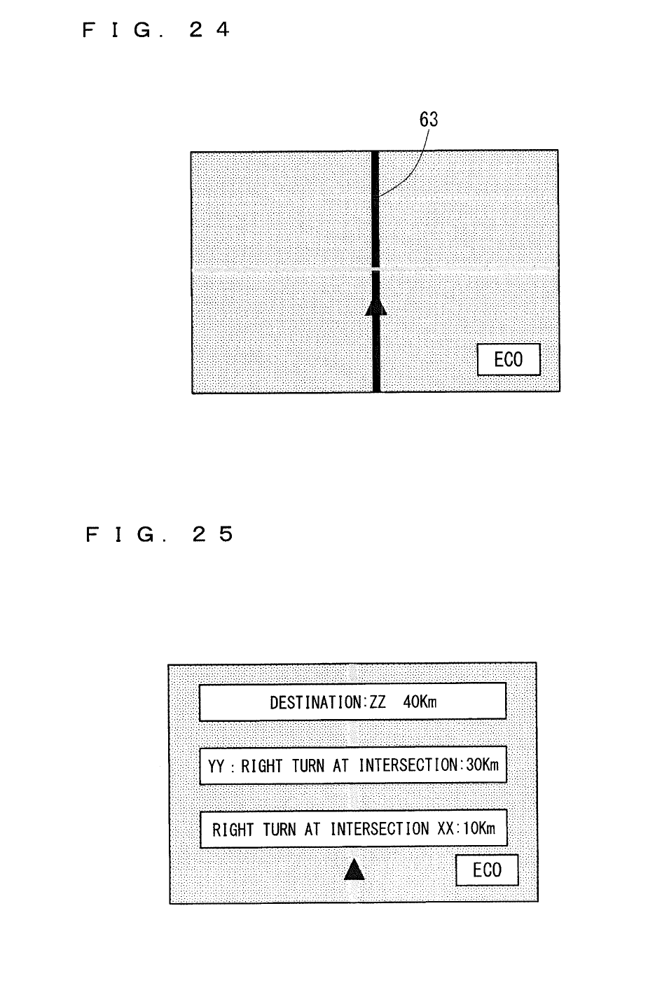

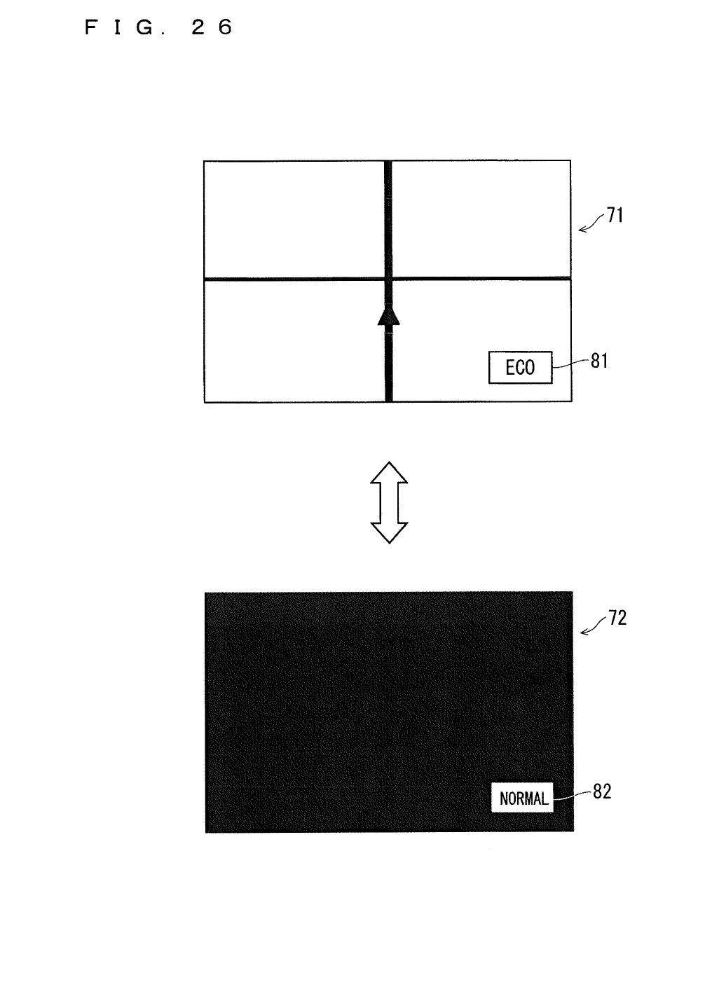

FIG. 22 shows an exemplary screen for the normal mode. FIGS. 23 to 25 each show an exemplary screen for the energy-saving mode. The screen of FIG. 23 is entirely black with no luminance. The screen of FIG. 24 is displayed dimly with reduced luminance of the entire screen. If only a route to be guided is displayed brightly, guidance of the route can be offered to a user effectively while the luminance of the screen is maintained low. As shown in FIG. 25, simple display can be made with reduced luminance. As shown in FIGS. 23 to 25, if an icon (such as an icon with indication “ECO”) indicating that a current mode is the energy-saving mode appears in part, the user becomes less likely to mistake the energy-saving mode for a power-off condition.

During display is made in the energy-saving mode with reduced luminance, a drawing process sequence executed by the information processing executing unit 13 is restricted. Only reducing luminance does not achieve sufficient energy-saving effect. Meanwhile, prohibiting or restricting a drawing process sequence additionally can achieve effective energy saving.

FIG. 26 shows switching between a screen 71 for the normal mode and a screen 72 for the energy-saving mode. The screen 71 includes an operational icon 81 for a shift from the normal mode to the energy-saving mode. The screen 72 includes an operational icon 82 for a switch from the energy-saving mode to the normal mode. A user can intentionally change a display mode by operating the icon 81 or 82. This enhances convenience further.

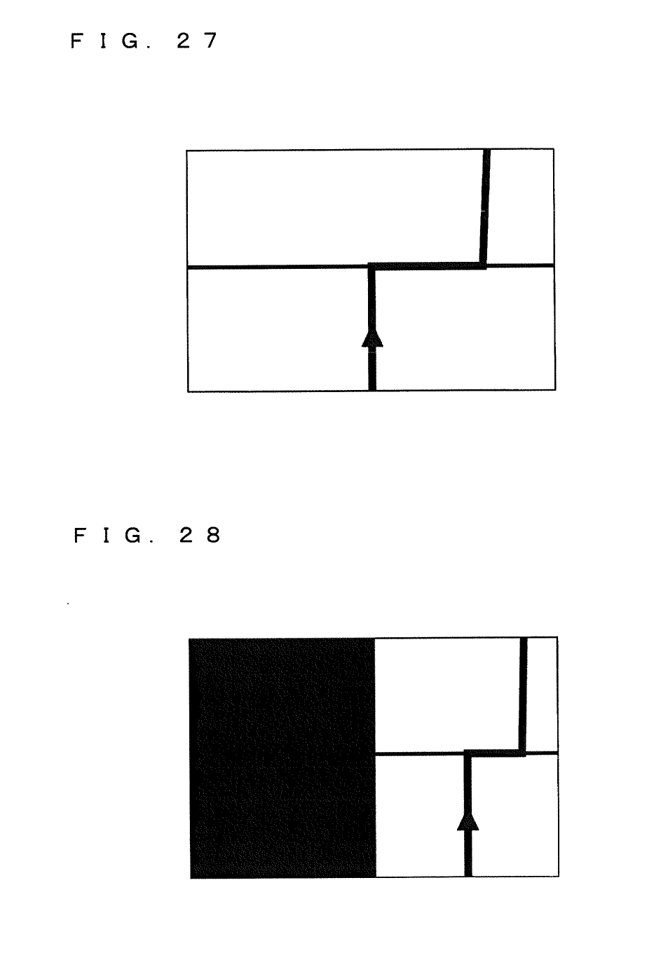

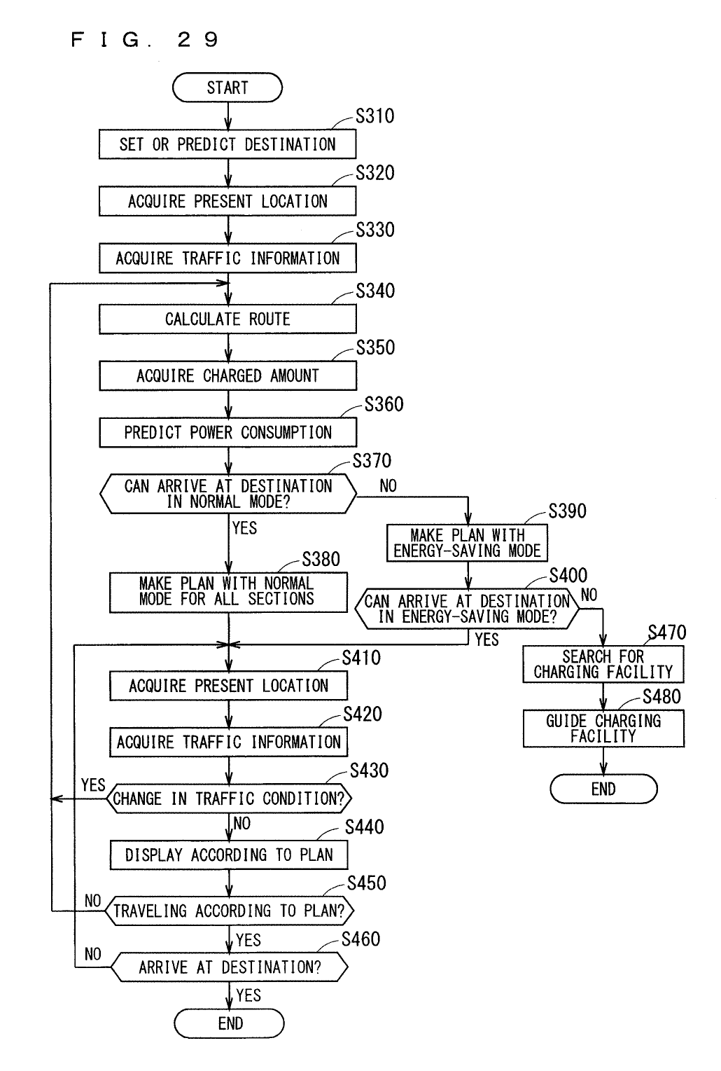

FIGS. 27 and 28 each show an exemplary route guidance screen to be displayed during route guidance in the energy-saving mode. The entire screen of FIG. 27 functions as a route guidance screen. In the example of FIG. 28, half of the screen keeps display in the energy-saving mode and a route guidance screen appears in the other half. It is desirable that even in the energy-saving mode, route guidance still be given for an important place such as a guidance intersection. Accordingly, both the methods shown in FIGS. 27 and 28 can achieve effective route guidance.

If detecting the occurrence of a certain unexpected issue such as an accident or a disaster through the communication unit 25, the operation mode planning unit 16 makes a determination such that drawing process is to be executed in the normal mode irrespective of an operation mode at the time of the occurrence. This determination is reflected immediately in the control over the information processing executing unit 13 through the controller 11. As a result, both power saving based on an energy-saving display plan and handling of an emergency can be achieved effectively.

If the unexpected issue is a jam and if the nearest intersection on a route is separated from a present location by a distance longer than a given distance, the operation mode planning unit 16 does not make a determination such that drawing process is to be executed in the normal mode. This suppresses an unnecessary shift to the normal mode, thereby enhancing energy-saving effect.

### C-4. Operation of Navigation Device 100C

FIG. 29 is a flowchart showing exemplary operation of the navigation device 100C described as an example of the display device for a mobile object according to the third embodiment.

When the navigation device 100C starts to operate, the information processing executing unit 13 sets a destination or predicts a destination (step S310). Based on a radio wave received from the GPS receiver 21, the information processing executing unit 13 acquires a present location of a vehicle on which the navigation device 100C is mounted (step S320). The operation mode planning unit 16 acquires traffic information from the communication unit 25 (step S330). The information processing executing unit 13 calculates a route to the destination (step S340), and supplies information about the route to the operation mode planning unit 16. The operation mode planning unit 16 acquires a charged amount of the vehicle based on vehicular information 52 (step S350), predicts power consumption based on the route information and the like (step S360), and determines whether the vehicle can arrive at the destination in the normal mode (step S370). If determining that the vehicle can arrive at the destination in the normal mode, the operation mode planning unit 16 makes a plan such that all sections of the route are to be displayed in the normal mode (step S380). If determining that the vehicle cannot arrive at the destination in the normal mode, the operation mode planning unit 16 makes a plan such that display is to be made in the energy-saving mode (step S390), and determines whether the vehicle can arrive at the destination in the energy-saving mode (step S400). If this determination shows that the vehicle cannot arrive at the destination in the energy-saving mode, the information processing executing unit 13 searches for the nearest charging facility (step S470), guides a route to this facility (step S480), and finishes the processing. If it is determined in step S400 that the vehicle can arrive at the destination in the energy-saving mode and when the process in step S380 is finished, the information processing executing unit 13 acquires a present location of the vehicle (step S410), and supplies the present location to the operation mode planning unit 16. Then, the operation mode planning unit 16 acquire traffic information (step S420). The operation mode planning unit 16 determines based on the acquired traffic information whether there has been a change in a traffic condition (step S430). In the presence of a change, the processing returns to step S340. In the absence of a change, the operation mode planning unit 16 supplies an operation mode responsive to the plan such that screen display is made according to the plan. The controller 11 controls the information processing executing unit 13 according to the supplied operation mode. Then, the information processing executing unit 13 executes information processing and the drawing unit 14 executes the drawing process in response to execution of this information processing (step S440). The operation mode planning unit 16 determines whether the vehicle is traveling according to the plan (step S450). If the vehicle is not traveling according to the plan, the processing returns to step S340. If the vehicle is traveling according to the plan, the operation mode planning unit 16 determines whether the vehicle has arrived at the destination (step S460). If a result of this determination shows that the vehicle has not arrived at the destination, the processing returns to step S410 to acquire a present location. If a result of this determination shows that the vehicle has arrived at the destination, the processing is finished.

The display device of the aforementioned structure according to the third embodiment determines whether a mobile object can arrive at a destination in the normal mode based on an energy condition of the mobile object. If it is determined that the mobile object cannot arrive at the destination in the normal mode, a display plan is made that uses the energy-saving mode in at least part of a route. Information processing responsive to an operation mode is executed according to this display plan and then a drawing process is executed. Accordingly, display in the energy-saving mode can be limited to the case in need of the energy-saving mode. This enables energy saving in the drawing process to consume much energy while avoiding damage on convenience inherent to the display device.

As shown in FIG. 21 according to the third embodiment, a normal section and an energy-saving section are provided. A section requiring important display is defined as the normal section. In the energy-saving section, the energy-saving process is performed only on the drawing process. Different energy-saving means may be employed in the energy-saving section that executes the process of reducing the clock frequency of the CPU 10C of FIG. 21, for example. The clock frequency of the CPU 10C may be controlled such that the CPU 10C operates on the normal number of clocks in the normal mode. The CPU 10C may be replaced by a hardware structure using an SOC (system on chip) formed of a multi-core CPU. The number of CPUs to operate in the multi-core CPU may be reduced in the energy-saving section. Alternatively, a peripheral unit may be subjected to the energy saving. As an example, a GPS receiver may be subjected to the energy-saving process to simplify the calculation process of a GPS signal or reduce a frequency of calculation. In the energy-saving section, the energy-saving process is not limited to the drawing process but it may be achieved by different means. Hence, the aforementioned structure enhances energy-saving effect further while making normal display in a section requiring display of an important issue. This can provide the display device of a high degree of usability.

In the third embodiment, as shown in FIGS. 23 to 28, display is made in an entirely black condition with no luminance, display is made dimly with reduced luminance, or simple display is made in the energy-saving mode. Alternatively, constraint may be imposed on display action or a drawing object may be restricted by using the method shown in the first or second embodiment.

In the third embodiment, there are two operation modes including the normal mode and the energy-saving mode. Alternatively, as shown in the first or second embodiment, the information processing executing unit 13 may have multiple energy-saving modes, and the operation mode planning unit 16 may make a display plan using a combination of the normal mode and the multiple energy-saving modes based on a give condition.

Even if the display device of the third embodiment is not the navigation device 100C but it may be a smartphone, a mobile phone, a PND (portable navigation device), a PDA (personal digital assistance), a tablet PC or the like employed by being supplied with power from a mobile object, the usefulness of the present invention is still maintained.

As shown in the third embodiment, an icon indicating that a current mode is the normal mode or the energy-saving mode may be prepared in the first and second embodiments. As shown in the third embodiment, in the first and second embodiments, an icon for switching between the normal mode and the energy-saving mode may be prepared and an operation mode may be switched in response to user's operation. Displaying an operation mode or switching an operation mode in response to user's operation enhances the convenience of a user further.

The embodiments of the present invention can be combined freely or each of the embodiment can be modified or omitted where appropriate without departing from the scope of the invention.

### REFERENCE SIGNS LIST

11 Controller
12 Operation mode determining unit
13 Information processing executing unit
14 Drawing unit
100A Navigation device

1-14. (canceled)

15. A display device comprising:
an information processing executing unit having a normal mode prepared as an operation mode for a normal drawing process and one or more energy-saving modes prepared as operation modes for drawing processes in which energy is consumed less than in said normal mode, said information processing executing unit executing information processing in each of the operation modes;
an operation mode determining unit that determines an operation mode for information processing to be executed by said information processing executing unit based on a given condition;
a controller that controls the operation of said information processing executing unit based on a result of a determination made by said operation mode determining unit; and
a drawing unit that executes a drawing process in response to execution of information processing by said information processing executing unit,
wherein said display device is mounted on a mobile object,
a drawing process responsive to said energy-saving mode is a drawing process sequence subjected to more strict constraint on display action than a drawing process responsive to said normal mode, and
said operation mode determining unit determines the operation mode based on an energy condition of said mobile object.

16. The display device according to claim 15, wherein said constraint on display action is restriction of a frequency of heading-up display update or prohibition of heading-up display.

17. The display device according to claim 15, wherein said constraint on display action is prohibition of at least one of bird's-eye view display and driver's-eye view display.

18. The display device according to claim 15, wherein said constraint on display action is prohibition of display of at least one of a narrow street, a 3D figure, a townscape, and an animation.

19. The display device according to claim 15, wherein
said operation mode determining unit determines based on an energy condition of said mobile object whether said mobile object can arrive at the nearest energy replenishing facility or a destination while said display device makes display action in said normal mode, and if a result of the determination shows that said mobile object cannot arrive at said nearest energy replenishing facility or said destination, said operation mode determining unit makes a determination such that a drawing process is to executed in said energy-saving mode.

20. The display device according to claim 19, wherein
said operation mode determining unit determines based on road traffic information whether said mobile object can arrive at said nearest energy replenishing facility or said destination.

21. The display device according to claim 15, wherein
if said mobile object is a hybrid electric car, said operation mode determining unit determines whether said mobile object is traveling in an electric car mode, and if a result of the determination shows that said mobile object is traveling in said electric car mode, said operation mode determining unit makes a determination such that a drawing process is to executed in said energy-saving mode.

22. The display device according to claim 15, wherein while a drawing process is being executed in said energy-saving mode, display is made indicating that the drawing process is being executed in said energy-saving mode.

23. The display device according to claim 15, wherein a drawing process in said energy-saving mode and a drawing process in said normal mode is switched in response to user's operation.

24. The display device according to claim 15, wherein said operation mode determining unit determines an operation mode based on user's operation.

25. The display device according to claim 15, wherein if the occurrence of a certain issue is detected, said operation mode determining unit makes a determination such that a drawing process is to be executed in said normal mode.

26. The display device according to claim 15, wherein said constraint on display action is prohibition of display of power spectrum of a voice.
